(19) United States
(12) Patent Application Publication
(10) Pub. No.: US 2019/0060680 A1
(43) Pub. Date: Feb. 28, 2019

(54) EMERGENCY ESCAPE APPARATUS FOR HIGH-RISE EVACUATION

(71) Applicant: Chien Min Lai, New Taipei (TW)

(72) Inventor: Chien Min Lai, New Taipei (TW)

(21) Appl. No.: 15/686,366

(22) Filed: Aug. 25, 2017

(51) Int. Cl. A62B 1/20

(52) U.S. Cl. CPC A62B 1/20

(57) ABSTRACT

The present invention relates to an emergency escape apparatus for high-rise evacuation. The emergency escape apparatus for high-rise evacuation comprises a main conveying track, perpendicularly set up on an outer wall of a building, with a S-shaped circular track formed by a main guide rail section and a plurality of turning and joining sections; a plurality of branch conveying tracks, each being an inclined track and arranged, corresponding to each of the turning and joining sections, at an external connection passage on each floor of the building; and a plurality of conveying carriers, respectively slidably arranged on the branch conveying tracks and close to the external connection passages. Thereby, even in the event of a fire or other disaster, even a person in a building of an ultra-high floor can be moved quickly to the safe area by means of the emergency escape device of the present invention.

### BACKGROUND OF THE INVENTION

### 1. Field of the Invention

The present invention relates to an escape apparatus having advantages such as being away from windows and beyond the reach of smoke and fire, no worry about crowded people, and capable of evacuating people rapidly with 100 percent safety in a few seconds after they fasten the safety belt and hang on a pulley; more particularly to an emergency escape apparatus applicable for superhigh floors, and especially to an emergency escape apparatus which is made of fireproof materials, has low cost, consists of an S-shaped main escape track that can be pre-installed or externally equipped and has a slow descending function in combination with a branch escape track prepared for residents on each floor, and can rapidly evacuate people trapped in a building to a safety place once fire or other disasters occur.

### 2. Description of the Related Art

High-rise buildings with increasing floors rapidly emerge in cities of China, which far exceeds the development pace of high-rise firefighting technologies, and high-rise fire safety becomes an issue concerned for urban safety. Cities with a lot of high-rise buildings have taken various measures against high-rise fires, and have adopted emergency rescue facilities such as helicopters for air rescue and high-rise aerial ladder trucks. Such passive rescue methods employed according to the situation of the fire can hardly achieve the optimal rescue effect, and therefore, various fire escape apparatuses are invented.

Conventional escape apparatuses can be classified into the following types:

1. Slow descending ropes, for example, high-altitude lifesaving devices, which mainly consist of a descending rope, a control box, a pressure reducing valve, and a safety belt. Such escape apparatuses are lack in protection to trapped people, so the trapped people easily suffer from secondary damages during descending, and the rescue efficiency is low.

2. Slow descending pipes for escape, for example, slow descending pipes for high-rise escape, which mainly consist of a fixed frame and a slide pipe, the fixed frame including a frame body cover plate, a cylinder seat, and a cylinder cover. When the bottom cylinder cover is opened, the built-in slide pipe falls down, and trapped people can go through the frame body and descend slowly by means of a strap and an elastic band inside the pipe body. The purpose of slow descending is achieved by using the principle of speed limiting through extrusion and friction. The apparatus has the following disadvantages:

(1) An inlet is generally designed on the roof of a building, and people rushing for escape may push against each other and trample over one another in order to fight for entrance;

(2) Such a slideway is installed on the outer wall of a high-rise building and is exposed to wind, sunshine and rain all the year round, so that it is hard to ensure the service life of the materials and the reliability and safety of the apparatus;

(3) The metal ornaments on the trapped people may scratch the lining of the slideway, and cause decrease of its strength.

Currently, high-rise buildings are equipped with very few escape apparatuses, and existing public escape apparatuses all have certain deficiencies. Therefore, it is of important value and significance for public safety of modern high-rise buildings to develop a public safe and rapid escape apparatus applicable to the whole floor units.

Therefore, to solve the above problems and improve the escape safety in the case of a disaster in a building, in view of the defects of the prior art, the inventor finally put forward the present invention to eliminate the defects of the prior art after careful experiments and researches with perseverance.

### SUMMARY OF THE INVENTION

In view of the above, the present invention provides an emergency escape apparatus for high-rise evacuation, in which a specialized S-shaped main escape passage is perpendicularly setup from the top floor to the ground floor of a building, and a specialized branch escape passage is designed on each floor and is connected and switched to the specialized S-shaped main escape passage. The S-shaped structure can reduce the sliding speed of trapped people on the tracks and improve the safety, and the trapped people can escape safely.

To achieve the purpose of the present invention, the present invention provides an emergency escape apparatus for high-rise evacuation, comprising: a main conveying track, a plurality of branch conveying tracks, and a plurality of conveying carriers; the main conveying track perpendicularly set up on an outer wall of a building, and comprising a main guide rail section and a plurality of turning and joining sections, wherein the main guide rail section and the turning and joining sections together forming an S-shaped circular track; a plurality of branch conveying tracks, each being an inclined track and arranged, corresponding to each of the turning and joining sections, at an external connection passage on each floor of the building, wherein each of the branch conveying tracks has a folded state and an unfolded state, the unfolded state is used for triggering change of the track direction of the corresponding turning and joining section, and thus each of the branch conveying tracks is joined to the main track section through the track of the turning and joining section; and the plurality of conveying carriers respectively slidably arranged on the branch conveying tracks and close to the external connection passages, wherein each of the conveying carriers is used for conveying a trapped person to pass through one of the branch conveying tracks from the external connection passage and triggering the unfolded state, so as to depart from the branch conveying track and move to a safety place through the main conveying track.

In an embodiment of the present invention, the main conveying track and the branch conveying tracks are constructed and set up on the outer wall after the construction of the building is completed.

In an embodiment of the present invention, the main conveying track and the branch escape tracks are embedded in the outer wall of the building.

In an embodiment of the present invention, a turnout structure is arranged between the main guide rail section and each of the turning and joining sections, each turnout structure consists of a switch, a frog, a dual-track, and a switch tie, and the track direction is changed by using a turning rod according to the lever principle.

In an embodiment of the present invention, the branch conveying track is divided into a primary track section and a secondary track section, a linking member is arranged on an upper end of the track at the joint of the primary track section and the secondary track section, and the linking member is linked to the track of the secondary track section. Also, the linking member may be a balance member having balance gravity and/or on-off functions, e.g. a piston-type balancer, a seesaw-type linking member, an on-off controller.

In an embodiment of the present invention, each of the conveying carriers comprises a suspended main guide rail wheel set, a suspended bearing bracket, a T-shaped suspended rod shaft, a hanging rod, and a foldable transverse supporting bracket; and safety buckling belts are sleeved on two ends of the foldable transverse supporting bracket.

In an embodiment of the present invention, wherein a main load-bearing fixed frame extending from top to bottom of the building is set up on the main conveying track and at positions close to and away from the outer wall, and thus the main conveying track is stably arranged on the outer wall of the building.

In an embodiment of the present invention, the main load-bearing fixed frame comprises a front main load-bearing fixed frame and a rear main load-bearing fixed frame, the front main load-bearing fixed frame and the rear main load-bearing fixed frame are respectively provided with a front auxiliary load-bearing fixed frame and a rear auxiliary load-bearing fixed frame, the front and rear main load-bearing fixed frames are at the same height as the front and rear auxiliary load-bearing fixed frames, and a plurality of L-shaped transversely fixing and connecting brackets is arranged between the front and rear main load-bearing fixed frames and the front and rear auxiliary load-bearing fixed frames.

In an embodiment of the present invention, the specification and size of each of the branch conveying tracks are identical to the specification and size of the main conveying track.

In an embodiment of the present invention, a buffering section with a slow slope is further joined to an outlet at the end of the main guide rail section; a supporting frame connected to the track of the buffering section and fixed to the ground is arranged at the buffering section; and the buffering section is in a linear shape, a helical shape, or a hollow-square shape.

### BRIEF DESCRIPTION OF THE DRAWINGS

FIG. 1 is a schematic structural diagram of the configuration of an emergency escape apparatus according to the present invention.

FIG. 2 is a schematic structural diagram of the emergency escape apparatus set up by a setup construction method according to the present invention.

FIG. 3 is a schematic structural diagram of a branch conveying track according to the present invention.

FIG. 4 is a schematic structural diagram of dual-track configuration with reference to FIG. 3 according to the present invention.

FIGS. 5A-5B is a schematic structural diagram of single-track configuration with reference to FIG. 3 according to the present invention.

FIGS. 6A to 6D are schematic structural diagrams illustrating the switching of a folded state to an unfolded state with reference to FIG. 3 according to the present invention.

FIG. 7 is a schematic path diagram of track switching of a turnout structure according to the present invention.

### DETAILED DESCRIPTION OF THE PREFERRED EMBODIMENTS

To understand the technical features, objectives and effects of the present invention more clearly, specific embodiments of the present invention are illustrated in detail below with reference to the accompanying drawings.

The emergency escape apparatus for high-rise evacuation disclosed by the present invention does not require any electromechanical device. An S-shaped circular structure from the top floor to the ground floor of a high-rise building is manufactured and set up by using a setup construction method, or vertical escape load-bearing tracks corresponding to the height of different floors or the number of external windows and arranged positions thereof are manufactured and set up by using the setup construction method and corresponding to the number of floors or the number of external windows and arranged positions thereof on each floor of a building. The vertical escape load-bearing track can be divided into a fixedly oriented primary track section and track sections with changeable track directions, and the fixedly oriented primary track section and the track sections with changeable track directions together form an S-shaped circular structure. The vertical escape load-bearing track is also called an S-shaped main escape track.

In the emergency escape apparatus of the present invention, a branch escape track that can be connected to the S-shaped main escape track is set up on each floor by using the same setup construction method. The branch escape track may have an obliquely designed guide rail structure, and can be divided into a fixed primary track section and a track section with a popup or extensible structure. Specifically, the branch escape track in idle state is normally not connected to the S-shaped main escape track, and only when the branch escape track is used, the track section with a popup or extensible structure triggers the track sections with changeable track directions of the S-shaped main escape track, such that the branch escape track is connected to the S-shaped main escape track. Reserved offsets are formed between the fixedly oriented primary track section and the track sections with changeable track directions to cause discontinuity. The S-shaped main escape track and the branch escape track are guide rails adopting gaps between steel bars and having sections of I-shaped structures, and serve as traveling tracks for guide rail wheels of a manned escape hanging bracket.

The emergency escape apparatus of the present invention can be constructed in the following two setup construction methods: (1) after the construction of a high-rise building is completed, an S-shaped main escape track and branch escape tracks of the emergency escape apparatus of the present invention are constructed and set up on the outer wall of the building; (2) during the construction of a high-rise building, an S-shaped main escape track and branch escape tracks to be embedded in the outer wall of the building are planned on the surface of the wall.

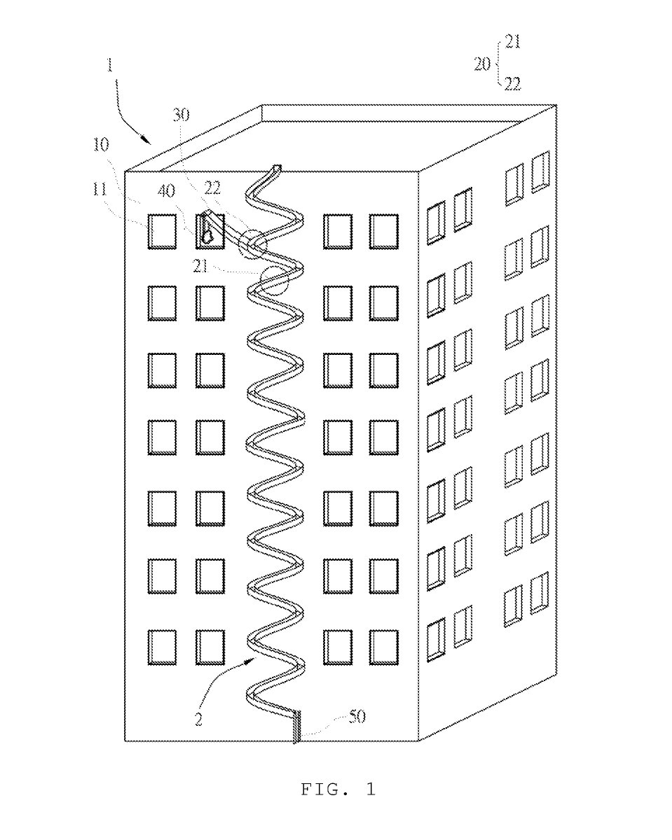

As shown in FIG. 1, the emergency escape apparatus 2 of the present invention consists of a main conveying track 20, a plurality of branch conveying tracks 30, and a plurality of conveying carriers 40. The main conveying track 20 is perpendicularly constructed and set up on at least one outer wall 10 of a building 1, and has a main guide rail section 21 and a plurality of turning and joining sections 22. The main guide rail section 21 and the turning and joining sections 22 together form an S-shaped circular track. Taking a top view of the building, the S-shaped circular track is of single-track or dual-track configuration like a railway track, and the present invention is not limited thereto.

Dual-track configuration is illustrated below. As shown in FIG. 7, a turnout structure 200 is arranged between the main guide rail section 21 and each of the turning and joining sections 22. Each turnout structure consists of a switch, a frog, a dual-track, and a switch tie. Two movable tracks are turned by a turning rod according to the lever principle. The switch is a turnout switching device, which can be used to switch or lock a turnout, such that a trapped person sliding toward the main conveying track 20 through the conveying carrier 40 can enter the main guide rail section 21 from the branch conveying track 30. How the branch conveying track 30 is switched and joined to the main conveying track 20 and how the sliding down speed of trapped people is reduced through the S-shaped structure design of the main conveying track 20 to improve the escape safety are described below.

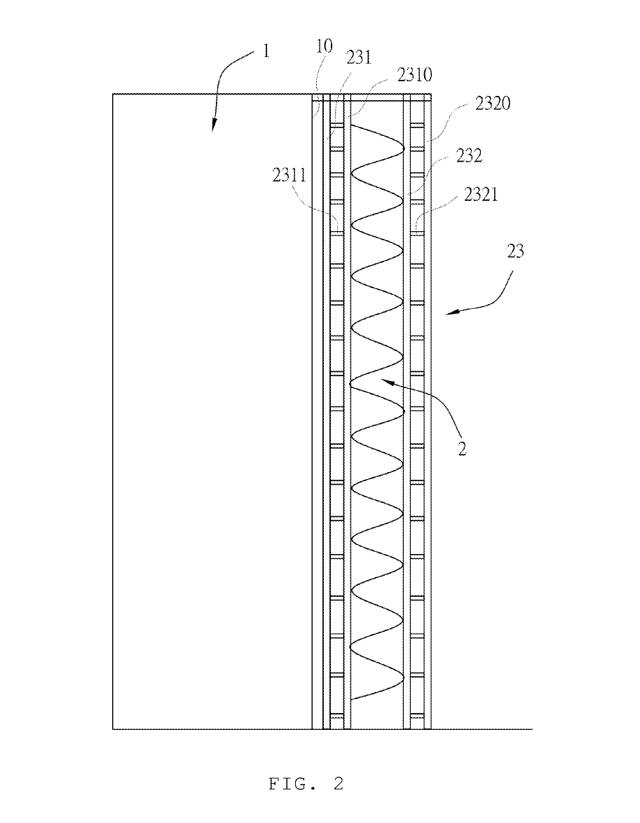

As shown in FIG. 2, a main load-bearing fixed frame 23 extending from top to bottom of the building may be set up on the main conveying track 20 and at positions close to and away from the outer wall 10, and thus the main conveying track 20 can be stably arranged on the outer wall 10 of the building 1. The main load-bearing fixed frame 23 has a front main load-bearing fixed frame 231 and a rear main load-bearing fixed frame 232 that are respectively disposed close to the outer wall 10 and away from the outer wall 10, and the front and rear main load-bearing fixed frames (231, 232) are respectively provided with a front auxiliary load-bearing fixed frame 2310 and a rear auxiliary load-bearing fixed frame 2320. The front and rear main load-bearing fixed frames (231, 232) are at the same height as the front and rear auxiliary load-bearing fixed frames (2310, 2320). A plurality of ⊏-shaped transversely fixing and connecting brackets (2311, 2321) is arranged between the front and rear main load-bearing fixed frames (231, 232) and the front and rear auxiliary load-bearing fixed frames (2310, 2320). The ⊏-shaped transversely fixing and connecting brackets (2311, 2321) are used for connecting, supporting and fixing the front and rear main load-bearing fixed frames (231, 232). The number of the ⊏-shaped transversely fixing and connecting brackets can be increased according to requirements to enhance the overall load-bearing strength and stability of the main conveying track 20, such that the main conveying track 20 is more firmly arranged and may not shake or be distorted, for example, the ⊏-shaped transversely fixing and connecting brackets (2311, 2321) may be set up at a spacing of 1 to 2 meters. The spacing between the ⊏-shaped transversely fixing and connecting brackets (2311, 2321) may be adjusted according to actual requirements, as long as it facilitates the stability of the main escape passage. The purpose is to prevent distortion and deformation of the main conveying track 20 set up on the front and rear main load-bearing fixed frames (231, 232), thereby ensuring the fixed structure of the whole escape track, and the present invention is not limited thereto. According to another embodiment of the present invention, the main conveying track 20 may also be directly fixed on the surface of the outer wall 10 through a track fixing device (not shown), and a load-bearing fixed frame does not need to be used.

An outlet at the end of the main conveying track 20 is mainly disposed at the height of one floor, and the height of the outlet may also be determined according to the external space of a building, as long as it is ensured that trapped people do not directly touch the ground. An elastic cushion or the like or a pool filled with sand is placed below the outlet at the end of the track, and the purpose is to reduce the impact force caused by descending of the trapped people, thereby preventing the trapped people from getting injured.

According to an embodiment of the present invention, a buffering section (not shown) with a slow slope and being directly communicated with the outlet at the end of the track may be formed at the track section close to the outlet at the end of the track, and a supporting frame 50 connected to the track of the buffering section and fixed to the ground is arranged at the buffering section of the main conveying track 20. The buffering section may be designed into a linear shape, a helical shape, a hollow-square shape or the like according to the ground space outside the building, and the present invention is not limited thereto. The buffering section maybe designed according to on-site space environment to ensure successful escape of the trapped people.

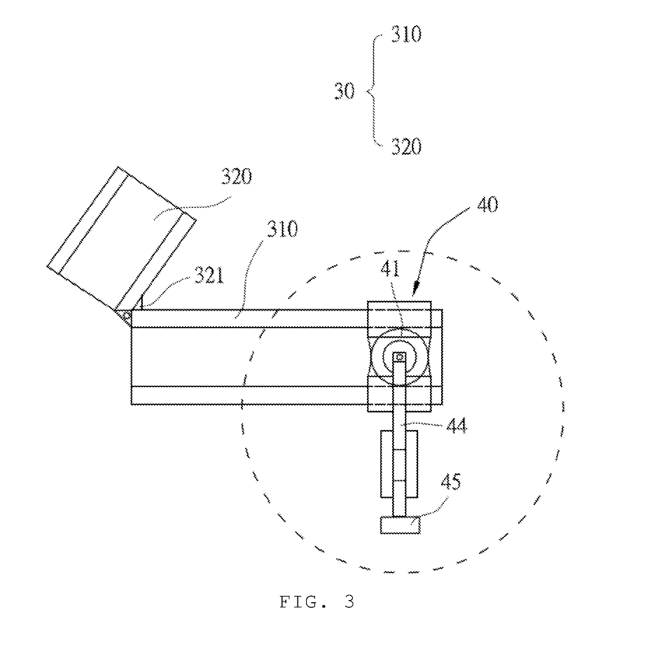

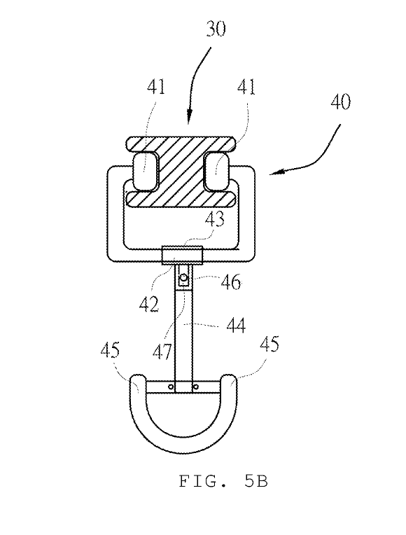

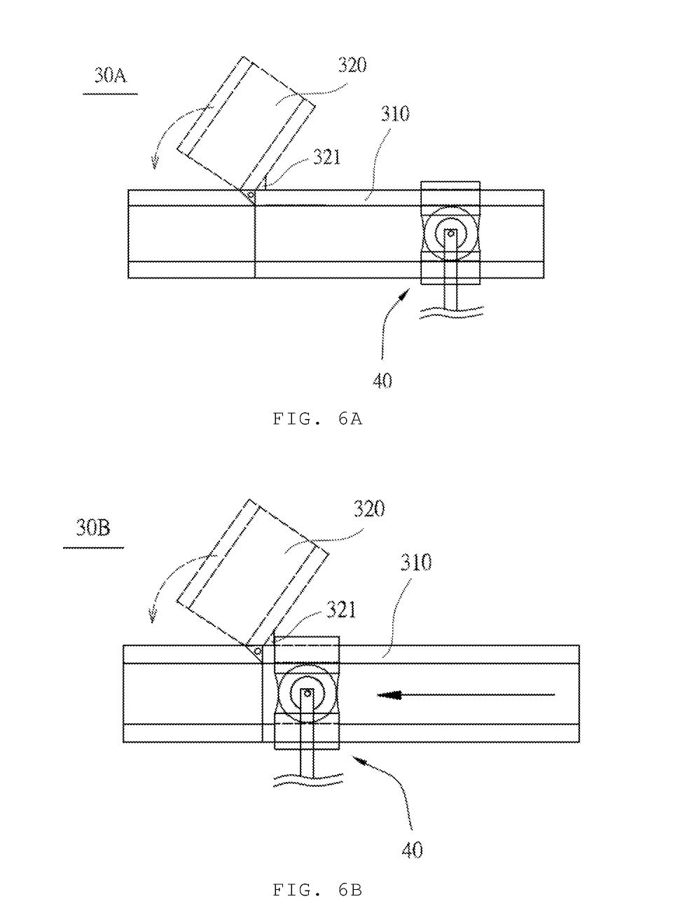

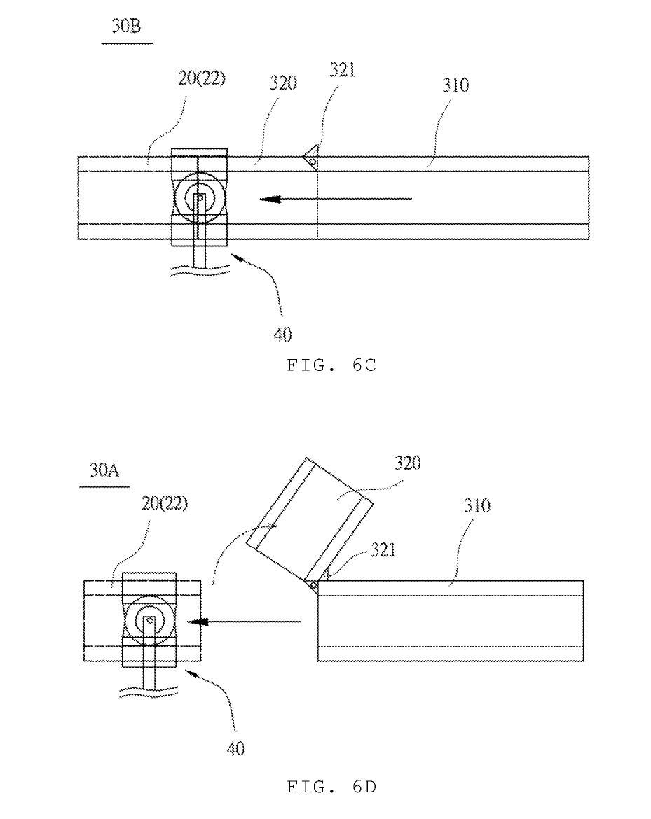

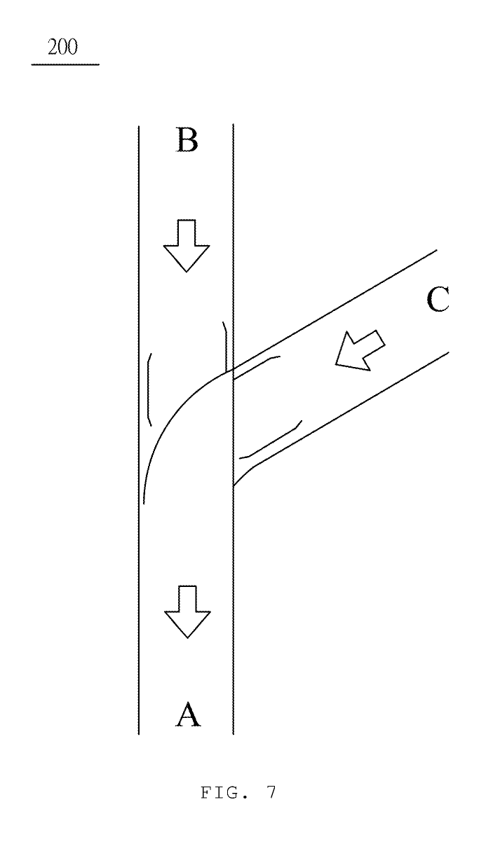

Referring to FIG. 3, the branch conveying track 30 is an inclined track and is arranged, corresponding to each of the turning and joining sections 22, at the position of an external connection passage 11 on each floor of the building 1. The external connection passage 11 may bean external window disposed on each floor unit of the building 1, or an external window or a balcony arranged for families on each floor; therefore, a trapped person can escape through the conveying carrier 40 provided on the branch conveying track 30 and is not stuck due to body size. Each branch conveying track 30 is designed into dual-track configuration with the same specification and size as the main conveying track 20, and has a folded state 30A and an unfolded state 30B. The branch conveying track 30 has a fixed primary track section 310 and a secondary track section 320 with a popup or extensible structure. FIGS. 6A to 6D show the secondary track section 320 having a popup structure, and the present invention is not limited thereto. A linking member 321 is arranged at the joint of the primary track section 310 and the secondary track section 320 of the branch conveying track 30, and the linking member 321 is linked to the track of the secondary track section 320. Each branch conveying track 30 in the unfolded state 30B triggers change of the track direction of the corresponding turning and joining section 22, and thus the branch conveying track 30 is joined to the main track section 21 through the track of the turning and joining section 22. Further, the end of the branch conveying track 30 is in the same direction as the downward direction of the main guide rail section 21 of the main conveying track 20 and the two tracks are merged, which ensures smooth and continuous running of the conveying carrier 40 for carrying trapped people.

In view of the above, similar to the main conveying track 20, a main load-bearing fixed frame (not shown) extending from top to bottom of the building is set up on the primary track section 310 of the branch conveying track 30 and at positions close to and away from the outer wall 10, and thus the branch conveying track 30 can be stably arranged on the outer wall 10 of the building 1. The overall architecture of the primary track section 310 of the branch conveying track 30 is not shown, and persons of ordinary skill in the art can learn about the technical features of the present invention with reference to the related drawings and descriptions of the main conveying track 20. Further, according to another embodiment of the present invention, the branch conveying track 30 may also be directly fixed on the surface of the outer wall 10 through a track fixing device (not shown), and a main load-bearing fixed frame does not need to be used.

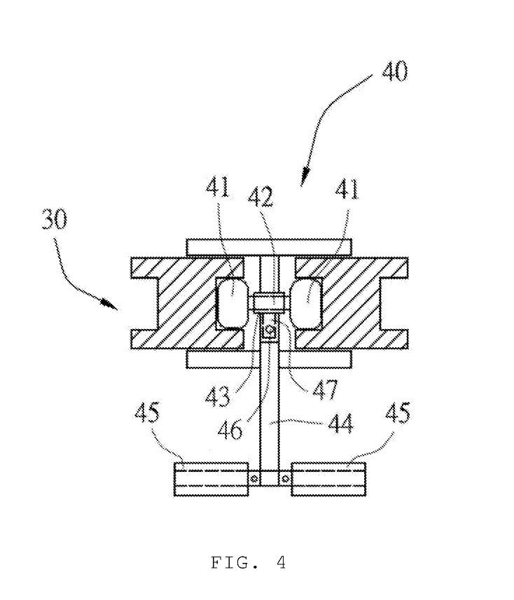

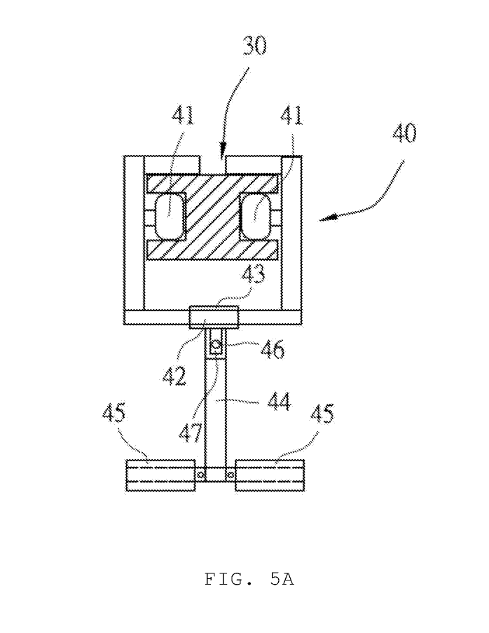

Together referring to FIG. 3, FIG. 4, FIGS. 5A to 5B, the conveying carriers 40 may be respectively slidably arranged on the branch conveying tracks 30 and are close to the positions of the external connection passages 11. The conveying carrier 40 may be a suspended manned escape hanging bracket and includes a suspended main guide rail wheel set 41, a suspended bearing bracket 42, a T-shaped suspended rod shaft 43, a hanging rod 44, and a foldable transverse supporting bracket 45. Safety buckling belts can be sleeved on two ends of the foldable transverse supporting bracket 45 and are used for carrying trapped people. The conveying carrier 40 is used for conveying a trapped person to pass through one of the branch conveying tracks 30 from the external connection passage 11 and triggering the unfolded state 30B of the branch conveying track 30, so as to depart from the branch conveying track 30 and move, through the main conveying track 20, to a safety place, for example, the outlet at the end of the main conveying track 20. In view of the above, the main guide rail wheel set 41 is a ⊏-shaped guide wheel set containing guide wheels, the T-shaped suspended rod shaft 43 capable of rotating in 360 degrees on the suspended bearing bracket 42 is arranged at the center of the suspended bearing bracket 42, and a suspended shaft hole 46 capable of swinging from side to side is provided at a lower end of the T-shaped suspended rod shaft 43. A fixed shaft 47 is arranged on an upper end of the hanging rod 44 for carrying trapped people, and can be connected to the suspended shaft hole 46. A lower end of the hanging rod 44 is an L-shaped port and is provided with a T-shaped foldable transverse supporting bracket 45, and a sheath may be provided on the foldable transverse supporting bracket 45. The foldable transverse supporting bracket 45 can be folded and put away in normal times, and can be unfolded by hand to lay flat when used. When the foldable transverse supporting bracket 45 lays flat, a trapped person can unfold the safety buckling belts on two ends of the foldable transverse supporting bracket 45 and buckle up under the arms or around the waist and so on. Besides, as shown in FIG. 5B, the foldable transverse supporting bracket 45 may also be a hanging ring design structure, and the trapped persons may hang the safety buckling belts with a hook design on the hanging ring by hanging the hook and then buckle the safety buckling belts up under the arms or around the waist and so on

The conveying carriers 40 can be respectively hung on the branch conveying tracks 30. Once a fire breaks out, trapped people can sequentially put on the conveying carriers 40 and slide forward along the obliquely designed branch conveying tracks 30 by their own weight, then rapidly switch from the branch conveying tracks 30 to smoothly slide down along the main conveying passage 20, pass through the buffering section before falling on a buffering pad (the safety place) arranged below the outlet, and rapidly leave the outlet after taking off the conveying carriers 40, thereby facilitating the escape of the following trapped people and preventing accidents like trampling. Further, an entrance-only baffle plate is designed on the end of each branch conveying track 30 close to the external connection passage 11. After the conveying carrier 40 is hung on the branch conveying track 30, the conveying carrier 40 is retained by the baffle plate and cannot be taken out any more, which prevents departure of the conveying carrier 40 from the branch conveying track 30 due to misoperation of people during escape.

The connecting process of the branch conveying track 30 and the main conveying track 20 is described below.

As shown in FIG. 6A, when a trapped person starts to slide down through the conveying carrier 40, the branch conveying track 30 is still in the folded state 30A. Then, as shown in FIG. 6B, when the ⊏-shaped guide wheel set above the main guide rail wheel set 41 of the conveying carrier 40 presses against the linking member 321, the secondary track section 320 of the branch conveying track 30 rotates and pops up due to downward gravity of the trapped person, and thus the branch conveying track 30 is in the unfolded state 30B and is connected to the primary track section 310 to form a linear track, such that the trapped person can continuously slide down. Meanwhile, as shown in FIG. 6C, the end of the secondary track section 320 triggers the turnout structure 200, such as a turnout structure on a railway, of the turning and joining section 22 in the main conveying track 20. Two movable tracks are turned by the switch and the turning rod according to the lever principle, such that the original passage (the path AB shown in FIG. 7) between the turning and joining section 22 and the main track section 21 of the main conveying track 20 is switched to a passage (the path AC shown in FIG. 7) formed by connection and merging of the branch conveying track 30 and the main track section 21. Therefore, the trapped person departs from the branch conveying track 30 and moves on along the main conveying track 20, the popup secondary track section 320 is recovered by the linking member 321 of the branch conveying track 30, and the branch conveying track 30 returns to the original folded state 30A, as shown in FIG. 6D.

According to another embodiment of the present invention, the external parts of the main conveying track 20 and the branch conveying tracks (30) may be designed and installed in a closed state, to protect trapped people from being injured by fire, prevent the escape passage from being exposed to wind, sunshine and rain, and prolong the service life of the escape passage.

The outlet of the emergency escape apparatus 2 is designed at the height of one floor, and has a buffering section joined to the main conveying track 20. The buffering section has a slow slope and is designed with a buffering section outlet. A load-bearing fixed bracket, arranged on the top surface of the buffering section, supports the top surface of the buffering section and is fixed on the ground. The buffering section outlet is about 1 meter above the ground, and an elastic cushion or the like or a pool filled with sand may be placed below the outlet, to prevent trapped people from being accidentally injured due to the impact force caused by descending.

The present invention has the following beneficial effects:

1. The emergency escape apparatus of the present invention is adopted for escape from a building, and is applicable for superhigh floors. Particularly, the emergency escape apparatus has advantages such as being away from windows and beyond the reach of smoke and fire, no worry about crowded people, and capable of evacuating people rapidly with 100 percent safety in a few seconds after they fasten the safety belt and hang on a pulley. The escape apparatus of the present invention is a specialized fire escape passage applicable to high-rise floors, which is made of fireproof materials, has low cost, consists of an S-shaped main escape track that can be pre-installed or externally equipped and has a slow descending function in combination with a branch escape track prepared for residents on each floor, and can rapidly evacuate people trapped in a building to a safety place once fire or other disasters occur.

2. The branch conveying tracks are arranged on the external connection passages of each floor and are not connected to the main conveying track in normal times, which effectively prevents people with malicious intention from trespassing along the main conveying track and through the branch conveying tracks. Only when a trapped person uses the conveying carrier for escape, the pushing force produced by body descending pushes against the linking member in the secondary track section of the branch conveying track, and the track of the secondary track section pops up and forms a linear track with the primary track section. The popup track triggers the turnout structure (including a switch, a frog and so on) of the main conveying track, the turning rod is driven to divert the direction of the track of the turning and joining section according to the lever principle, and the turning and joining section is connected and merged with the branch conveying track, such that the trapped person successfully moves to the S-shaped circular track of the main conveying track and successfully escapes to the safety place.

3. Auxiliary load-bearing fixed frames are designed on the left and right sides of the main load-bearing fixed frame and are connected and fixed by welding, screwing and other manners to make the auxiliary load-bearing fixed frames at the same height as the main load-bearing fixed frame. ⊏-shaped transversely connecting and fixing brackets are respectively arranged in the front and rear main load-bearing fixed frames, and are used for connecting and maintaining the stability of the front and rear main load-bearing fixed frames. ⊏-shaped transversely connecting and fixing brackets are also arranged between the front and rear auxiliary load-bearing fixed frames, to ensure the stability of the main conveying track set up on the front and rear main load-bearing fixed frames, thereby preventing distortion, deformation, offset and shaking.

The spacing of the ⊏-shaped transversely connecting and fixing brackets can be increased or reduced according to on-site situations. The connecting and fixing brackets can be installed in various forms as long as they are good for the stability and firmness of the main load-bearing fixed frame fixed to the building.

The embodiments of the present invention are described above with reference to the accompanying drawings, and the present invention is not limited thereto. The specific embodiments are merely illustrative and are not intended to limit the present invention. Persons of ordinary skill in the art can make various modifications under the enlightenment of the present invention and without departing from the principle of the present invention as well as the protection scope of the appended claims. All the modifications shall fall within the protection scope of the present invention.

### LIST OF REFERENCE NUMERALS

1 Building

10 Outer wall

11 External connection passage

2 Emergency escape apparatus

20 Main conveying track

21 Main guide rail section

22 Turning and joining section

23 Main load-bearing fixed frame

200 Turnout structure

231Front main load-bearing fixed frame

232 Rear main load-bearing fixed frame

2310 Front auxiliary load-bearing fixed frame

2320 Rear auxiliary load-bearing fixed frame

2311 ⊏-shaped transversely fixing and connecting bracket

2321 ⊏-shaped transversely fixing and connecting bracket

30 Branch conveying passage

30A Folded state

30B Unfolded state

310 Primary track section

320 Secondary track section

321 Linking member

40 Conveying carrier

41 Main guide rail wheel set

42 Suspended bearing bracket

43 T-shaped suspended rod shaft

44 Hanging rod

45 Foldable transverse supporting bracket

46 Suspended shaft hole

47 Fixed shaft

50 Supporting frame

What is claimed is:

1. An emergency escape apparatus for high-rise evacuation, comprising:
a main conveying track, perpendicularly set up on an outer wall of a building, and comprising a main guide rail section and a plurality of turning and joining sections, wherein the main guide rail section and the turning and joining sections together forming an S-shaped circular track;
a plurality of branch conveying tracks, each being an inclined track and arranged, corresponding to each of the turning and joining sections, at an external connection passage on each floor of the building, wherein each of the branch conveying tracks has a folded state and an unfolded state, the unfolded state is used for triggering change of the track direction of the corresponding turning and joining section, and thus each of the branch conveying tracks is joined to the main track section through the track of the turning and joining section; and
a plurality of conveying carriers, respectively slidably arranged on the branch conveying tracks and close to the external connection passages, wherein each of the conveying carriers is used for conveying a trapped person to pass through one of the branch conveying tracks from the external connection passage and triggering the unfolded state, so as to depart from the branch conveying track and move to a safety place through the main conveying track.

2. The emergency escape apparatus for high-rise evacuation according to claim 1, wherein the main conveying track and the branch conveying tracks are constructed and set up on the outer wall after the construction of the building is completed.

3. The emergency escape apparatus for high-rise evacuation according to claim 1, wherein the main conveying track and the branch escape tracks are embedded in the outer wall of the building.

4. The emergency escape apparatus for high-rise evacuation according to claim 1, wherein a turnout structure is arranged between the main guide rail section and each of the turning and joining sections, each turnout structure consists of a switch, a frog, a dual-track, and a switch tie, and the track direction is changed by using a turning rod according to the lever principle.

5. The emergency escape apparatus for high-rise evacuation according to claim 1, wherein the branch conveying track is divided into a primary track section and a secondary track section, a linking member is arranged on an upper end of the track at the joint of the primary track section and the secondary track section, and the linking member is linked to the track of the secondary track section.

6. The emergency escape apparatus for high-rise evacuation according to claim 1, wherein each of the conveying carriers comprises a suspended main guide rail wheel set, a suspended bearing bracket, a T-shaped suspended rod shaft, a hanging rod, and a foldable transverse supporting bracket; and safety buckling belts are sleeved on two ends of the foldable transverse supporting bracket.

7. The emergency escape apparatus for high-rise evacuation according to claim 1, wherein a main load-bearing fixed frame extending from top to bottom of the building is set up on the main conveying track and at positions close to and away from the outer wall, and thus the main conveying track is stably arranged on the outer wall of the building.

8. The emergency escape apparatus for high-rise evacuation according to claim 7, wherein the main load-bearing fixed frame comprises a front main load-bearing fixed frame and a rear main load-bearing fixed frame, the front main load-bearing fixed frame and the rear main load-bearing fixed frame are respectively provided with a front auxiliary load-bearing fixed frame and a rear auxiliary load-bearing fixed frame, the front and rear main load-bearing fixed frames are at the same height as the front and rear auxiliary load-bearing fixed frames, and a plurality of ⁻E -shaped transversely fixing and connecting brackets is arranged between the front and rear main load-bearing fixed frames and the front and rear auxiliary load-bearing fixed frames.

9. The emergency escape apparatus for high-rise evacuation according to claim 1, wherein the specification and size of each of the branch conveying tracks are identical to the specification and size of the main conveying track.

10. The emergency escape apparatus for high-rise evacuation according to claim 1, wherein a buffering section with a slow slope is further joined to an outlet at the end of the main guide rail section;
and the buffering section is in a linear shape, a helical shape, or a hollow-square shape.
